(19) United States
(12) Patent Application Publication
(10) Pub. No.: US 2025/0183778 A1
(43) Pub. Date: Jun. 5, 2025

(54) TRIDENT INDEPENDENT ENERGY SYSTEM

(71) Applicant: Richard R. Wescott, Manchester, NH (US)

(72) Inventor: Richard R. Wescott, Manchester, NH (US)

(21) Appl. No.: 18/445,642

(22) Filed: Dec. 4, 2023

(51) Int. Cl. H02K 53/00; F03G 7/10

(52) U.S. Cl. CPC H02K 53/00; F03G 7/115

(57) ABSTRACT

The claims discussed hereinbefore depict processes comprising heterogeneous components and devices where the present invention has revealed processes wherein said components and devices may be assembled in a manner as explained hereinbefore to achieve certain desired results. Said desired results being the generating of electricity and/or alternative energy sources. The present invention reveals processes of generating said electrical and/or mechanical energy for an undeterminable period, or until such point in time where the components are switched off.

### BACKGROUND

Throughout history individuals have sought various methods to generate usable amounts of electrical and mechanical energy. Since Thomas Edison's New York City steam plant in 1882, many methods of generating electricity have been developed. Concerning mechanical energy, although there exist entire communities who will forever rely on nothing more than the physical energy produced by man and animal, numerous other options do now exist. What has not been developed in an overly significant manner is a process to produce unlimited sources of electrical and mechanical energy in an eco-conscious manner without any harmful emissions.

Drivers used in the processes of producing electrical and mechanical energy may use many of the processes developed and fueled by gasoline, diesel fuel, oil, nuclear fission, geo-thermal sources, solid waste, liquid propane, natural gas and coal. Prime movers used in the processes of producing electrical and mechanical energy may use wind and water sources. Further, solar panels may also be used in the process of producing electricity. Thus far, there has not been developed any known processes of generating usable amounts of electricity and mechanical energy without the use of any of the above processes or resources.

Concerning the generating of electricity: Generators used in the process of producing electricity may be either alternating current, hereafter AC, or direct current, hereafter DC. Further, for the purposes of the present invention, the words “generator” and/or “alternator” shall be considered to be synonymous with one another. Although the present invention is capable of using either, a three-phase AC generator will be the exemplified generator throughout the forthcoming descriptions and claims, unless otherwise specified. Finally, though an AC generator is manufactured with many parts and components, the present invention will focus its primary attention on the rotor and stator of the generator.

For exemplary purposes of the present invention, unless otherwise specified, a 100,000-watt AC generator will be exemplified as engineers for the generator manufacturer and the inventor consulted extensively on this particular generator. Specifically, it was reported to the inventor that the exemplified generator may be capable of producing 100,000 continuous watts of electricity if a constant rotor speed of approximately 1800 revolutions per minute, hereafter RPM, could be maintained. Further, it was reported to the inventor, at full capacity, the resistance of the magnetic force between the rotor and the stator will require approximately 392-foot pounds of rotational torque, hereafter fpt, in order to turn the rotor.

Concerning the generating of mechanical energy: In addition to AC generators, the present invention processes will also be exemplifying hydraulic pumps and hydraulic motors that are widely used in many industries such as manufacturing and production factories as well as in in the marine industry. Concerning the 100,000-watt AC generator discussed above (under load), it would be necessary to use an approximate 140 horsepower electric motor to turn the rotor of the AC generator a continuous and approximate 1800 RPM. Therefore, the inventor will use the same specifications of the 140-horsepower electric AC motor in the following exemplary and explanatory process of generating usable amounts of mechanical energy with the use of hydraulic components.

A forthcoming exemplary embodiment will be discussing a hydraulic power unit, hereafter HPU. A HPU may be purchased over the counter or may be specifically ordered for a certain application. In general, the components of a HPU may comprise an AC motor, where the AC motor may be connected to a hydraulic pump specifically selected to be compatible with one another. There may be a tank which holds hydraulic fluid, and there may be filters, strainers, controllers, connectors, and the likes thereof. The inventor would liken the HPU as the heart of an open hydraulic system configuration. That is to say, hydraulic fluid is pumped from the HPU throughout the hydraulic system through a series of hydraulic lines and components in order to serve a desired purpose and then is returned to the tank prior to being pumped through the system once again. Although not exemplified in the present invention, a closed hydraulic system that may not normally use a tank, may also be used in the present invention. In summary, whether an opened or closed hydraulic system is used, both may be capable and suitable for various applications of the present invention, and generally, both may use an AC motor as the driver for the hydraulic pump.

There are three types of hydraulic if motors that may be used within the present invention: the vane motor, the piston motor and the gear motor. The exemplified hydraulic motors for the present invention will be the piston and vane motors. More specifically, the piston motor develops its torque as pressurized hydraulic fluid is introduced to the piston units of the cylinders to convert fluid energy to mechanical energy which then causes the rotation of the piston motor driveshaft. The vane motor develops its torque by the introduction of the pressurized hydraulic fluid acting on the exposed surfaces of the vanes, which slide in and out of the rotor connected to the driveshaft. The inventor had consulted with both, a hydraulic systems engineer and a hydraulic motor engineer who had recommended the aforementioned hydraulic motors to the inventor for the purposes defined hereinafter. Further, those skilled in the art had informed the inventor that the hydraulic pump necessary to drive the two aforesaid hydraulic motors, for the purposes defined hereinafter, would require a driver (AC motor) capable of producing approximately 390 fpt to counteract the pressure and/or resistance produced by the forthcoming exemplified hydraulic system when operating at full capacity.

During the consultations with those skilled in the arts of hydraulics, it was determined that the forthcoming exemplary hydraulic piston motor may be capable of producing approximately 250 fpt at approximately 1800 RPM, approximately 500 fpt at approximately 900 RPM, and approximately 750 fpt at approximately 450 RPM with the implementation of gear reducers. These are all exemplary numbers, and all numbers are in the approximate area of normal operation. The forthcoming exemplary hydraulic vane motor was reported to produce approximately 140 fpt at an approximate 1800 RPM.

Being a boating enthusiast, the inventor consulted with one skilled in the art of marine motors. Providing this person with the various fpt and RPM discussed above, the inventor inquired if a fuel powered motor was replaced with a hydraulic motor having any of the above specified outputs if a watercraft would be able to be propelled. The conversation led to information relating to torque and RPM, however, it was reported to the inventor that any of the above output specifications could certainly be used in the marine industry to propel various watercraft efficiently.

In summary of what the inventor had learned through his consultations with various professionals skilled in the various arts of the components that may comprise the Trident Independent Energy Systems processes, hereafter TIES processes, that no matter if one is attempting to drive a generator, propeller, wheel, track or industrial machinery, as long as the selected driver or mover is capable of providing the mechanical energy necessary, as recommended by the manufacturer of the component being driven, there would be no issue on what the driver or mover might be.

The inventor has a basic working knowledge of household and older model Automobile electrical systems. That is to say, he has completely wired both homes and automobiles. The inventors grandfather was the owner/operator of a name brand home power products business, I.e. generators, lawnmowers, snowblowers, small tractors and the like. The inventor had learned and retained much from the tutelage of his grandfather. The inventor has always been fascinated with taking things apart to see how everything worked. His grandfather introduced the inventor to a large pile of motors, starters, generators, transmissions and the like. He was invited to take anything in the pile apart and to ask any questions that he might have. The inventor discovered much with his inquisitive nature, analytical mind and extremely patient grandfather.

It will be the intention of the inventor to facilitate a clear and non-ambiguous understanding of all aspects of the present invention. Specifically, the inventor provides the following hypothetical explanatory and exemplary scenario in order to assist in the facilitation of highlighting the crux of the present invention.

The problem to be solved is that a machine shaft needs to be able to be freely spun by hand. All that is known is that the shaft presents a resistance that will require approximately 392 fpt applied to the shaft in order to counteract said resistance.

The first part of the solution is. Understanding the basics of overcoming mechanical resistance. The inventor would first secure a hub, or collar onto the shaft where he would be able to attach levers. We're the inventor to attach a two foot lever to the hub, he would need to exert approximately 196 pounds of pressure on the end of the lever in order to turn the shaft. In the simplest of terms, the longer the lever, the less pressure would need to be exerted on the end of the lever. The application of the approximate 196 pounds of pressure at a distance of two feet from the center of the shaft presents approximately 392 fpt being applied to the shaft.

The second part of the solution is where the inventor attaches a second two foot lever opposite the first lever, similar to a two blade airplane propeller. There would be two levers opposite each other spanning a length of approximately 48″. If the inventor were to secure an approximate 98 pound weight on the end of one of the two levers, he would now need to exert approximately 98 pounds of manual pressure on the end of the unweighted lever in order to apply approximately 392 fpt to the shaft.

The third part of the solution would be if the inventor added an additional 2 two-foot levers to the hub, similar to a four-blade airplane propeller and each lever had an approximate 49-pound weight attached to the end of it. The inventor would now be able to rotate the shaft with very little effort being applied to the weighted configuration. The approximate 392-foot pounds of resistance has been counteracted by the attachment of the approximate 49-pound weights being attached to the end of each lever.

The final part of the solution is where the inventor now replaces the approximate 49-pound weights at the end of each two-foot lever with approximate 55-pound weights. This configuration would now be able to apply an approximate 440 fpt to the shaft when the weighted configuration is spun. The resultant effect of the weighted configuration is that once spinning, it will take minimal effort to continue spinning the weighted configuration as the only resistance, should the configuration have been meticulously aligned and balanced, would be the friction of any bearing systems and the air against the components of the weighted configuration. By the addition of specific weights being placed at a specific distance from the center of the shaft, the 220-pound weighted configuration has taken mechanical advantage over the 392-foot pounds of resistance by applying approximately 440-foot pounds of rotational torque to the shaft.

The inventor had also consulted with a metallurgist when pondering whether a flywheel would work in this particular. Application after discovering that flywheels at high RPM could burst with deadly consequences. The metallurgist was able to provide the inventor with a list of several specific forms of steel that would serve as a good host for his purposes.

The inventor understood that in order to mimic the effect of the weighted configuration in a safer manner he would need a specifically weighted wheel, or the like, with a specific diameter and a specific thickness to be applied to a specific application. This led the inventor to consulting with an engineer who has his skills in the art of designing and providing blueprints for one-off industrial application flywheels. This individual confirmed that such a wheel with the above specifications of approximately 220 pounds being evenly distributed over the outer circumference of the approximate 48″ diameter steel wheel could be designed and engineered.

For exemplary purposes only, the forthcoming exemplified steel wheel, hereafter modified flywheel, does not necessarily need to be 48″ in diameter. The approximate 48″ is only the exemplified diameter.

As an example, using the aforementioned shaft requiring approximately 392 fpt in order to freely rotate it; the inventor rounded up the fpt necessary to rotate the shaft to being approximately 400 fpt. The inventor then added an additional 10% more fpt for the efficiency of the TIES processes when operating. This brings the total of approximately 440 fpt being applied to the shaft by the modified flywheel when spinning, far exceeding the necessary approximate 392 fpt as earlier discussed. Therefore, an exemplary approximate 48″ diameter modified flywheel with an approximate 220 pounds of weight evenly distributed over the outer circumference of the modified flywheel presents approximately 440 fpt to the shaft when the modified flywheel is spun. Of note: The discussion concerning the additional 10% of weight is exemplary only and may not be necessarily required to achieve the desired result.

Using an approximate 24″ diameter modified flywheel, the weight required to turn the shaft discussed above would necessarily have to be approximately 392 pounds evenly distributed over the outer circumference of the modified flywheel when rotating at approximately 1800 RPM under a full load. Rounding up the approximate 392 fpt to approximately 400 fpt, then adding an additional 10% for efficiency, the modified flywheel would present approximately 440 fpt to the aforementioned shaft when rotating at approximately 1800 RPM. Any resistance presented by the shaft, bearing systems and the air against the modified flywheel would be counteracted by the weighted modified flywheel.

As explained hereinbefore, using an approximate 48″ diameter modified flywheel will require approximately half of the weight of the approximate 24″ diameter modified flywheel in order to achieve a like result. Therefore, should the approximate 48″ diameter modified flywheel consist of having approximately 220 pounds of weight evenly distributed over the outer circumference of the modified flywheel when revolving at approximately 1800 RPM, this would also present approximately 440 fpt to the exemplary shaft discussed hereinbefore.

As a final example, an approximate 72″ diameter flywheel would require approximately half of the weight of the approximate 48″ diameter modified flywheel. Therefore, were an approximate 72″ modified flywheel to have approximately 110 pounds of weight evenly distributed over the outer circumference of the modified flywheel when revolving at approximately 1800 RPM, this would also present approximately 440 fpt to the shaft discussed hereinbefore with a like result of the discussed 24″ diameter and the 48″ diameter modified flywheels.

Wherefore, it is undeterminable to predict or even venture a guess to the infinite weights and diameters of modified flywheels in future embodiments, as the TIES processes are anticipated to take on undeterminable custom configurations which may require a specific diameter and thickness modified flywheel. Further, custom weights may be infinitely fractional. This does not take away from the spirit and scope of the present invention as it is the intention of the inventor that the TIES processes be employed in as many applications as individuals or groups are able to imagine.

The inventor has also consulted with an engineer skilled in the art of fabricating steel. The inventor discovered that indeed a specifically designed modified flywheel would be able to be fabricated by those skilled in the art.

Upon consulting with those skilled in the various arts discussed hereinbefore, the inventor learned that his weighted configuration could be engineered for any of the explanatory sizes of modified flywheels discussed above, as well as any others that may be desired. Wherefore, the inventor is able to provide a viable precision balanced modified flywheel for explanatory and exemplary purposes of the present invention. The inventor would hold that the processes taught in the forthcoming descriptions and claims is in the spirit of the United States Supreme Court holding in Anderson's Blackrock, Inc. v. Pavement Salvage Co., 396 U.S. 57, that “Innovation, advancement, and things which add to the sum of useful knowledge are inherent requisites in a patent system which by constitutional command must promote the progress of useful arts. This is a standard expressed in the Constitution and it may not be ignored.” Having compiled the information discussed hereinbefore, the inventor will now discuss the TIES process.

One of the definitions of the word “Trident” means “having three processes.” This is why the name Trident was chosen. One of the three processes is having a starting system that will engage the modified flywheel in order to crank and spin the modified flywheel to approximately 1800 RPM, much like a starter for an automobile. This may comprise an automotive style flywheel, a spur gear or some other configuration being attached to the modified flywheel in order for the starting system to mechanically engage and crank the modified flywheel to an exemplary approximate 1800 RPM. For the purposes of the present invention, this will be referred to as a gear collar (which may or may not have actual gears). The starting process led the inventor to consulting with an engineer of high torque heavy equipment diesel engine starters. The inventor learned that a DC heavy equipment starter may in fact crank the exemplary modified flywheel to approximately 1800 RPM for the necessary short duration of time. Further, it was discovered that custom DC starters could be engineered for starting the TIES processes, and multiple DC starter systems could also be made available for the starting process. Noteworthy: Although DC starters may be sufficient for certain embodiments of the TIES processes, it may not be the preferable starting system for all applications. As an example, the inventor has consulted with an engineer skilled in the art of industrial machinery transmissions and starter systems. The inventor discussed an exemplary 1,000,000-watt AC Generator where an exemplary 2200-pound modified flywheel may be necessary for such an application, The engineer confirmed that an AC multi-stage starting system, some possibly using industrial transmissions, could be engineered for the purposes expressed by the inventor. Therefore, it is possible to have engineered starting systems for a variety of sizes and weights of modified flywheels.

The next part of the process is selecting the component to be driven. As discussed hereinbefore, a 100,000-watt AC generator will be exemplified to generate electricity and a hydraulic pump will be exemplified to generate mechanical energy. These processes will involve mechanically connecting a modified flywheel to the component selected to be driven, I.e., the AC generator or the hydraulic pump. There will also need to be a necessary electrical connection between the AC power panel and the continuous duty AC motor on each TIES process. The forthcoming exemplified 100,000-watt AC generator and hydraulic pump, in order to operate at their full potential, and if driven by an AC motor, would each require an approximate 140 horsepower AC motor which would provide approximately 440 fpt at approximately 1800 RPM. Although an approximate 1800 RPM is the exemplary speed for the processes of the present invention, it is exemplary only. The various components that may comprise the TIES processes are readily available at various RPM, such as approximately 900 RPM, approximately 3600 RPM, approximately 7200 RPM and more. Therefore, for consistency only, an approximate 1800 RPM will be the discussed and exemplified speed for the forthcoming descriptions.

The final process is selecting a continuous duty AC motor that will be capable and suitable of maintaining the approximate 1800 RPM of the modified flywheel once the starting system has been disengaged from said modified flywheel. As will be exemplified forthcoming, if the continuous duty AC motor, the modified flywheel and the components being driven have been meticulously aligned and balanced, once the modified flywheel has passed the moment of inertia and is spinning at approximately 1800 RPM, a continuous duty fractional horsepower AC motor may be capable of producing enough energy to maintain the approximate 1800 RPM of the modified flywheel that would be necessary to produce the desired results of the forthcoming exemplary embodiments of the present invention. Although a continuous duty fractional horsepower AC motor may be capable and suitable to continue turning the exemplified modified flywheel at approximately 1800 RPM, for the efficiency of the TIES processes and the purposes of the exemplary embodiments, the inventor will utilize a continuous duty AC motor rated at approximately 1% (rounded up or down) of the approximate foot pounds of resistance of the shaft of the device to be driven. For the purposes of the present invention the exemplified AC motor(s) will be rated at approximately 4 horsepower, and be motors of continuous duty.

### Long Felt Need

The inventor would like to discuss for a moment the long felt need for the present invention. The inventor has lived through electrical blackouts and brownouts throughout the world. He has witnessed pseudo fuel shortages on numerous occasions in order to increase big oils profit margins. Further, electricity and energy resources in general continue to be weaponized against communities and nations. Entire energy systems are being destroyed in order to leave human beings in the cold and dark in an attempt to break their spirit. Underdeveloped areas of the world would benefit tremendously by having a consistent and safe supply of electrical and mechanical energy readily available to them. Even the United States would benefit greatly from additional sources of electricity. Title 7, chapter 31 s/s 901-918C of the United States Code Service, titled “Rural Electrification” discusses the urgent need to bring renewable energy resources into rural communities. The Department of Energy and the Foundation of Energy Security and Innovations also indicate such an urgent need in the United States. The United States government reports that an average household in this Country consumes approximately 1500 kilowatt hours of electricity per month. This being an average of approximately 2.03 kilowatt hours per hour. News channels across the Country continually report that shortages of electricity are a significant issue in this Country.

It does not matter whether or not there exists an available means for persons to charge their electric vehicles, they are being forced into purchasing them. Recently, news agencies have reported and interviewed people that live in California that are forced to use gasoline powered generators to charge their electric vehicles. This does not even begin to make sense. Again, in California, electric power is often interrupted by rolling blackouts during certain seasons where electric vehicles cannot be charged during these blackouts.

California and many other regions of the world have severe water shortages, yet have readily available access to ocean water. Large scale ocean water desalinization and filtering systems would be of tremendous help; however, they require an extreme amount of electricity to operate. As an example, San Diego, California has such a plant that is said to produce 50 million gallons of potable water per day. It is also said that this plant consumes well in excess of 1,000,000 watts of electricity per hour.

Areas of natural and human caused disasters around the world have a need for readily available resources of electric and mechanical energy for both responders and the residents. Portable water desalinization and filtering systems could produce limitless gallons of potable water per day.

Countries and companies weaponize and hold hostage fuel sources to the everyday person. Yet big oil reports record profits along with these extremely high prices on fuel. No-one should need to choose between putting food on the table or oil in the tank to heat their home, yet everyday they do.

The inventor has been following the many reports indicating that the nations entire grid system, including electricity transmissions lines that would span around the world three times are in need of immediate upgrading. Perhaps these transmission lines stretched across the Country need not have to exist.

There is also the human cost of battery operated vehicles that most would rather not know about or would turn their heads to. The elements needed for the high power battery systems is provided in large part by forced child labor. Children are mining and dying as they gather the materials for the batteries that may no longer be necessary to operate an electric vehicle.

In the early part of 2023 the United States Capital was forced to close down due to a loss of electricity. Such an event cannot help but to call attention to the overall energy crisis that even the United States government falls victim to.

Recently there have been successful and thwarted domestic terrorism attacks on the vulnerable electric grid. There is an urgent need for alternative solutions that cannot be targeted as a “soft target” for domestic terrorism.

Also in recent history OPEC has ordered the reduction of oil production which will have a direct effect on the American consumer. Adversaries of the United States such as Venezuela, Iran, Iraq and others should not be the countries that America relies on for receiving its energy resources from.

The United States Supreme Court had said in the matter Waite v. United States, 63 S. Ct. Cl., 438 “securing new and unique applications of power in a way not heretofore done or suggested is a patentable invention.” The inventor would certainly argue that the long felt need is both clear and present.

Concerning the advantages of the present invention, the inventor cannot possibly predict or imagine all the exemplary embodiments that will manifest from the TIES processes. The limits of exemplary embodiments are limited only to one's imagination and common sense. The inventor can anticipate a few of the forthcoming exemplary embodiments of the TIES processes coming into fruition:
The TIES processes may be developed to provide electrical and mechanical energy for the propulsion of vehicles and vessels of the land, air and water without the need for known fuel sources and/or a deadly electrical battery system, as the TIES processes provide on-demand, not stored energy;
The TIES processes are easily able to be rushed to areas of natural disasters in order to provide electrical and mechanical energy for relief efforts;
The TIES processes are able to be deployed to underdeveloped areas of the world in order to aid in an infrastructure for further and future development;
The TIES processes are able to be deployed to military and civilian aid encampments around the world where usable amounts of electricity and mechanical energy is available in minutes, without requiring any fuel sources;
The TIES processes are highly scalable. The TIES processes are able to produce exemplary embodiments for camping, homes, construction sites, hospitals, hotels, island resorts, rural communities, towns, cities, and beyond;
The TIES processes may eliminate the necessity for the anticipated major overhaul of the electric grid system where the TIES processes are able to be located safely in the near vicinity of the consumer where high-power transmission lines may not be necessary;
The TIES processes are able to be combined by those skilled in the art where large scale electricity producing power plants could be located safely within cities and could produce “on-demand” power during peak periods and systems could be shut down during non-peak periods. Further, for electrifying communities, the TIES processes are able to be set up in currently manned buildings, such as police departments, fire departments, town maintenance facilities, etc. This may serve as a deterrent to domestic terrorism where only unmanned resources are the preferred targets for a domestic attack;
The TIES processes may be developed and configured in such a manner as to provide electrical and mechanical energy in the transportation industry to propel trains, trucks, ships, etc.;
The TIES processes is likely to create entirely new manufacturing industries in numerous skill sets;
The TIES processes, as exemplified forthcoming, may be impervious to solar flares and EMP's; and
The TIES processes, if widely accepted, may reverse the effects of global warming.

Recently, the inventor was reading an article where permits were issued for a 300,000 watt solar farm that would create electricity for household consumption. The project is said to cost millions of dollars and take over three years to complete. The inventor compared the electricity said to be delivered by the solar farm and the electricity that could be produced by the TIES processes, as exemplified forthcoming. If the components necessary were readily available, and most components are, the TIES processes would be capable of exceeding the output of the solar farm, 24 hours a day, 365 days a year within a few days or weeks, not months or years. The inventor would also predict that the cost of the TIES process in this application would be significantly less than that of a solar farm.

### The Failure of Others Test

The present invention culminated after decade's of a boys inquisitive nature and analytical mind followed him throughout his life of taking things apart to discover how they worked, and then put them back together, often with the assistance of his grandfather. It was not until working on a large unrelated project did the inventor discover a way in which to counteract the repelling forces between the rotor and the stator of an AC generator when operating at full capacity. The same discovery may also be used in counteracting the pressure of a hydraulic system when operating at full capacity. The flywheel, the AC generator nor the hydraulic pump are new discoveries, in fact they go back centuries. The inventor has certainly performed his due diligence, however, he has been unable to locate any prior art (non-fictional) that would indicate that an AC generator and/or a hydraulic pump and modified flywheel have ever been employed in such a fashion that is revealed in the present invention. If there were indeed such prior art, it seems that the world would know, just as they are now discovering and learning of the present invention. No-one is able to know exactly what is on the minds of others, and perhaps it was simply the inventors fascination with the force of electricity and mechanical motion when the present invention began developing in his mind. The one thing of certainty is that the inventor is forever grateful to his grandfather and all of the others skilled in the various arts who have unselfishly assisted the inventor to better understanding the heterogeneous combination of components that allowed him to develop processes for generating electricity and mechanical energy in an eco-conscious manner.

### SUMMARY OF INVENTION

The crux of the present invention is the revival and modification of the antiquated flywheel. Although flywheels are still currently used, the older style flywheels used for such equipment as punch machines, presses, metal shears and the like have mostly faded away by time and technology.

These older style flywheels, usually made with cast iron may not be able to safely function as necessary for the present invention. Flywheels for the present invention must be of sufficient strength to withstand the constant centrifugal forces that will be placed upon them by high RPM. The inventor discovered excessive centrifugal forces on a flywheel not designed and engineered for such a purpose may rupture or burst. The inventor has read articles of such incidents that have resulted in deadly consequences to others.

Flywheels of the past, generally, have been used to store kinetic energy that is used for sudden fluctuations of power needed by the devise being driven. Some have referred to the flywheel as a mechanical battery, or likened to an accumulator in a hydraulic system.

The present invention calls for a specifically sized and weighted engineered configuration used as a constant source of torque, as applied to a load by a lever. Once the modified flywheel begins rotating, the centrifugal forces associated with the rapid rotation urges the weight outwardly to the weighted outer circumference of the modified flywheel. The inertia of the modified flywheel contributes to preserve the uniformity and speed of the device being driven. Once the modified flywheel has reached the moment of inertia and is at a speed of approximately 1800 RPM, a continuous duty minimal horsepower AC motor may be able to maintain the centrifugal force and inertia for the conjoint purpose of maintaining the speed of the shaft of the device being driven.

Wind power has been described as “a process by which winds kinetic energy is converted into electricity by the use of wind turbines . . . the wind turns the blades which spin a shaft that connects to a generator to generate electricity,” Benson County Wind Farm LLC., v. Duke Energy Ind., LEXIS 181653. It is the blades extreme weight and length, much like a lever, that is able to provide the necessary torque to spin the shaft of the generator. In the present invention, much like a lever, the weight added to the outer circumference of the modified flywheel serves a like purpose of applying torque to the shaft of the rotor to counteract the resistance of the AC generators magnetic forces and/or the pressurized resistance of a hydraulic system. Unlike the wind turbine, the present invention does not cost millions of dollars to manufacture, nor millions of dollars to erect. Nor does the present invention have any negative consequences (death) to birds, animals and mammals.

The present invention combines numerous arts and reveals processes that generates electrical and mechanical energy without the use of fuels or other known alternative energy sources. Further, the present invention is able to obtain the materials necessary for its components from the United States and allied countries without having to resort to deals with adversarial nations, all the while providing one of the cleanest and safest energy sources contrived. Further, the battery systems used in the TIES processes are for cranking power, not storage capacity. Therefore, standard lead acid batteries are the recommended choice to start the TIES processes. Also, the plastic and lead from spent batteries is recycled and the sulfuric acid is capable of being regenerated at existing plants. The hydraulic fluid used in the TIES processes is available in biodegradable versions and is recyclable. The steel, metals, copper and other materials necessary to manufacture the components that may comprise the TIES processes have been confirmed by the inventor to all be available in the United States.

In the simplest of terms, the inventor would explain that the inclusion of the modified flywheel, as explained and exemplified hereinbefore and hereinafter, may counteract the pressure and/or resistance of the device being driven. Therefore, once the modified flywheel reaches the exemplified RPM through a chosen starting process, the AC motor (driver) may encounter resistance from only the chosen bearing system(s) and the air surrounding the modified flywheel.

### BRIEF DESCRIPTION OF THE FIGURES

FIG. 1 shows an exemplary embodiment of the configuration defined and explained as the crux of the present invention within paragraphs [0012]-[0017];

FIG. 2 shows an exemplary embodiment of an electrical and mechanical configuration of components and devices wherein the present invention, as a preferred embodiment, may produce 97,000 watts of usable electricity;

FIG. 3 shows an exemplary embodiment of an electrical and mechanical configuration of components and devices wherein the present invention may produce approximately 97,000 watts of useable electricity;

FIG. 4 shows an exemplary embodiment of an electrical and mechanical configuration of components and devices wherein the present invention may produce approximately 97,000 watts of usable electricity;

FIG. 5 shows an exemplary embodiment of an electrical, mechanical and hydraulic configuration of components and devices wherein the present invention may produce approximately 250 fpt to an unspecified device to be driven, approximately 140 fpt to an AC generator, and may produce approximately 7,000 watts of usable electricity; and

FIG. 6 shows an exemplary embodiment of an electrical and mechanical configuration of components and devices wherein the present invention may produce approximately 94,000 watts of usable electricity.

### DETAILED DESCRIPTION

Aspects of the present invention are disclosed in the following descriptions and related drawings to specific embodiments of the invention. Alternative embodiments may be devised without departing from the spirit and scope of the invention. Additionally, well known components of exemplary embodiments of the present invention may not be described in detail or will be omitted so as not to obscure the relevant details of the invention. Further, to facilitate an understanding of the description, discussions of several terms used herein follows.

As used herein, the word “exemplary” means “serving as an example, instance or illustration.” The embodiments described herein are not limiting, but rather exemplary only. It should be understood that the described embodiments are not necessarily to be construed as advantageous over other embodiments. Moreover, the terms “embodiments of the invention,” “embodiments” or “present invention” do not require that all embodiments of the invention include the disclosed features, advantages, or mode of operation. It should be further understood that the described embodiments may have multiple integration options and may be highly scalable. It has been contemplated by the inventor that that the described embodiments may be embodied as a system or systems, product or products, or method and may assume various and unpredictable forms.

In further exemplary embodiments, not discussed forthcoming, the present invention may include, however, is not limited to the inclusion of adapters, automated control systems, microprocessors, microcontrollers, timers, switches, diodes, shunts, resistors, mechanical and electrical regulators, voltage sensors, capacitors, emitters, controllers, semiconductors, valves, transducers, sensors, gauges, meters, relays, solenoids, mechanical and electrical converters, inverters, sprockets, transmissions, shafts, gears, gear boxes, and the likes thereof. All have been contemplated and it is the intent of the inventor to continue to facilitate a non-ambiguous understanding of the present invention limiting the details to only the basic and necessary information to understanding the TIES processes.

In order to assist in facilitating a clear understanding of the present invention and an attempt of others in the future from entering into linguistic gymnastics on the actual intent of the inventor, he will act as his own lexicographer for the following:
“AC” means for the purposes of the present invention, “alternating current”:
“AC power panel” means for the purposes of the present invention, “an electrical component that is capable and suitable for accepting generated electricity from an AC generator and distributing said electricity to other electrical components where said AC panel may comprise fuses, switches, circuit breakers and the like”;
“Approximate and/or approximately” means for the purposes of the present invention when discussing rotations per minute (RPM) “within a difference of 5%;
“AC power supply” means for the purposes of the present invention, “an electrical supply of AC energy that is capable of providing a sufficient amount of electricity to engage the starting process of the TIES processes”;
“Align” means for the purposes of the present invention, “to come into precise adjustment, the proper positioning, or state of adjustment of components in relation to each other”;
“Balance” means for the purposes of the present invention, “to bring to a state of equipoise, to equal or equalize in weight”;
“Bearing system” means for the purposes of the present invention, “bearing(s) which rotate in peripheral contact with a number of ball, roller or sleeve bearings; usually contained in a housing”; “Capable” means for the purposes of the present invention, “having the ability”;
“Carriage” means for the purposes of the present invention, “a part of a machine for supporting some other movable object or part”;
“Centrifugal force” means for the purposes of the present invention, “the apparent force that is felt by an object moving in a curved path that acts outwardly away from the center of rotation”;
“Component” means for the purposes of the present invention, “a constituent part of the TIES processes”;
“Configuration and/or configure” means for the purposes of the present invention, “a stable structural arrangement of components and/or devices of the TIES processes in order to achieve a desired result”;
“DC” means for the purposes of the present invention, “direct current”;
“DC battery” means for the purposes of the present invention, “an electrical supply of energy that is capable of providing a sufficient amount of electricity to engage the starting systems of the TIES processes”;
“Desalinize and/or desalinization” means for the purposes of the present invention, “to desalt”;
“Device” means for the purposes of the present invention, “a piece of equipment or a mechanism designed to serve a special purpose or to perform a special function”;
“Differential gears” means for the purposes of the present invention, “a drivetrain gear assembly connecting two collinear driveshafts in which the gear assembly is fashioned by one skilled in the art where said gear assembly allows for the direction and rotational speed of both driveshafts to be the same as the main driveshaft”;
“Driver” means for the purposes of the present invention, “a mechanical piece for imparting motion to another mechanical piece”;
“Driveshaft” and/or “shaft” means for the purposes of the present invention, “a balanced and aligned cylindrical bar used to support rotating pieces and transmit power and motion by rotation”;
“Electrical input and/or output. Connection point” means for the purposes of the present invention, “a predetermined location by the manufacturer of an electrical component and/or device where electrical connections are to be made”;
“Electrically connected” means for the purposes of the present invention, “connected in a manner that allows for the flow of electricity between two or more electrical components and/or devices to obtain a desired result”;
“Engineered” means for the purposes of the present invention, “designed and manufactured for a specific purpose”;
“Ensure” means for the purposes of the present invention, “to make sure, certain, or safe”;
“Fashion” means for the purposes of the present invention, “to form or make with the use of imagination and ingenuity”;
“Fittings” means for the purposes of the present invention, “a small often standard part”;
“Frame” means for the purposes of the present invention, “a steel, metal, carbon fiber, composite material or a combination of one or more of these materials used as a constructional system or structure that gives shape and strength when assembling components and devices”;
“Gear collar” means for the purposes of the present invention, “a component that may be fabricated as part of, or a component added to the modified flywheel that may have radial teeth or be smooth which purpose is to provide a surface on the modified flywheel, such as on the hub, for the spur gear to make contact with to initiate the starting process of the TIES processes;
“Flow” means for the purposes of the. Present invention, “a transfer of electrical and/or mechanical fluid energy”;
“Generate” means for the purposes of the present invention, “to produce”;
“Housing” means for the purposes of the present invention, “a support system for a mechanical part-a casing for enclosed bearings in which a driveshaft and/or other shaft revolves”;
“Hydraulically connected” means for the purposes of the present invention, “connected in a manner using capable and suitable hydraulic system parts and components that allows for the flow of hydraulic fluid between two or more hydraulic components in order to obtain a desired result”;
“Hydraulic fittings” means for the purposes of the present invention, “various fittings and components specifically engineered for the purposes of hydraulically connecting two or more hydraulic components together in order to obtain a desired result”;
“Hydraulic line” means for the purposes of the present invention, “a specifically engineered carrier which is capable of carrying highly pressurized fluid, where the hydraulic line may be rigid, semi-rigid, or flexible, all having been specifically engineered to allow for hydraulic fluid to flow from one hydraulic component to another”;
“Infinite” means for the purposes of the present invention, “subject to no limitation-infinitely fractional”;
“Inlet port” and/or “outlet port” means for the purposes of the present invention, “a predesignated manufactured orifice in a hydraulic component that allows for the intake and expulsion of hydraulic fluid:′
“Like manner, or the like, or the likes thereof” means for the purposes of the present invention, “in a fashion that is similar to the defined, explained and/or exemplified examples”;
“Mechanical” means for the purposes of the present invention, “relating to machinery”;
“Mechanically connected” means for the purposes of the present invention, “a direct or indirect connection made through intermediate parts and components that may comprise, but not limited to, welded connections, connection by fasteners (for example, belts, shafts, bolts, screws, nuts, rivets, quick release connections, latches, sleeves, or the likes thereof)”;
“Meticulously” means for the purposes of the present invention, “marked by extreme care in the consideration of details”;
“Modified flywheel” means for the purposes of the present invention, “a specifically engineered weighted configuration that has been specifically engineered to counteract the resistance within the magnetic field between the stator and/or the rotor of an AC generator and/or the resistance created by the pressure within the components of a hydraulic system.” It should be understood that the modified flywheel may comprise spokes or the like (radiating bars that extend from the hub of the rim of the modified flywheel), a hub (the center part of the rim of the modified flywheel), and may comprise a rim (the outer part of the modified flywheel joined to the hub by spokes). Further, the modified flywheel may be engineered as a solid mass instead of spokes, and may be made of steel, metal, iron, aluminum, carbon fiber, or other materials and/or a combination of one or more materials “;
“Moment of inertia” means for the purposes of the present invention, “the likelihood that a modified flywheel will continue to rotate with minimal effort after it has achieved the desired RPM”;
“Operate” means for the purpose of the present invention, “to perform a function or a series of functions”;
“Part” means for the purposes of the present invention, “a constituent member of a machine, device, component or other apparatus”;
“Power” means for the purposes of the present invention, “a source or means of supplying electrical and/or mechanical energy”;
“Prime mover” and/or “mover” means for the purposes of the present invention, “a natural source of motive power, such as wind and water which is applied to a driver”;
“Rigid” means for the purposes of the present invention, “devoid of flexibility”; Claim “Sleeve” means for the purposes of the present invention, “a tubular part (as a hollow axle or bushing) designed to fit over one or more other parts”;
“Spur gear” means for the purposes of the present invention, “a component or device that may have radial teeth parallel to its axis, or may be smooth which purpose is to make contact with the gear collar to initiate the starting process of the TIES processes”;
“Starting process” means for the purposes of the present invention, “a method that causes something to begin operating”;
“Suitable” means for the purposes of the present invention, “adapted for a specific use or purpose”;
“Switch” means for the purposes of the of the present invention, “a device for making, breaking, or changing the connection in an electrical circuit”; and
“Wire” means for the purposes of the present invention, “metal in the form of very flexible thread or slender rod.”

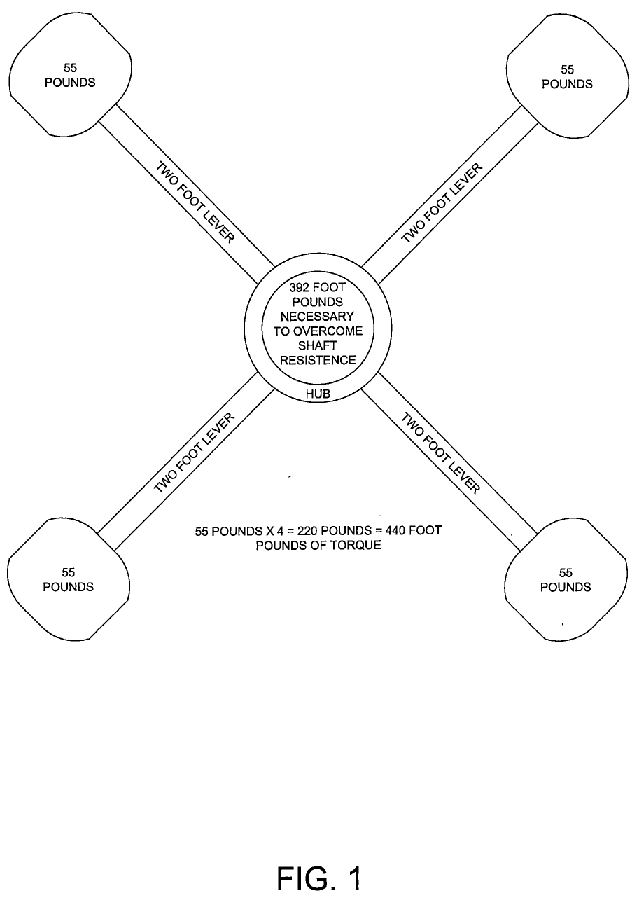

Now referring to exemplary FIG. 1, a concept drawing of an evenly weight distributed configuration which may counteract the approximate 392-foot pounds of resistance on the rotor shaft that may be created within the magnetic field between the stator and rotor when the exemplary 100,000-watt AC GENERATOR 102 is at full load. That is to say, when the AC GENERATOR 102 is producing electricity at its full capacity.

Further, the same configuration may. Also neutralize the approximate 390 foot pounds of resistance presented by the shaft of the exemplified HYDRAULIC PUMP 300 once the hydraulic system reaches its manufactured recommended pressure.

As depicted in FIG. 1, the 55-pound weights attached to the 4 two-foot levers present a combined weight of approximately 220 pounds. Because of the approximate two-foot distance between the aforesaid weights from the shaft, the resultant effect of said weights may apply an approximate 440-foot pounds of torque to the shaft when placed in motion.

The drawing in FIG. 1 is used for exemplary purposes only as it serves to reveal the though process of the inventor and does not depict an exemplary embodiment. As has been previously discussed, the inventor has consulted and confirmed that his contrived configuration could be engineered into a form of an efficient and safe modified form of a flywheel.

In providing a constructive reduction to practice, the inventor would hold that “levers” means for the purposes of the present invention, “a bar used to induce or compel force,” and is a timeless device used to obtain “leverage,” meaning for the purposes of the present invention, “the action of a lever or mechanical advantages gained by it.”

FIG. 1 is only indicative of the inventors thought process of using 4 weighted levers to obtain the desired result in which is achieved. As history reveals, the use of levers is, and has been a device and process or reducing or neutralizing opposing forces and/or resistance. It is also a process that has been utilized in varying methods for centuries. Further, it is a proven process which history has shown that it cannot, not work.

In the following exemplary embodiments, as the pressure and/or resistance increases in the components being driven, so does the foot pounds of torque as a result of the spinning MODIFIED FLYWHEEL 500. To wit, the increased foot pounds of torque provided by the increased speed of the MODIFIED FLYWHEEL 500 serves to counteract and/or neutralize the increasing pressure and/or resistance of the component(s) being driven increasing speed.

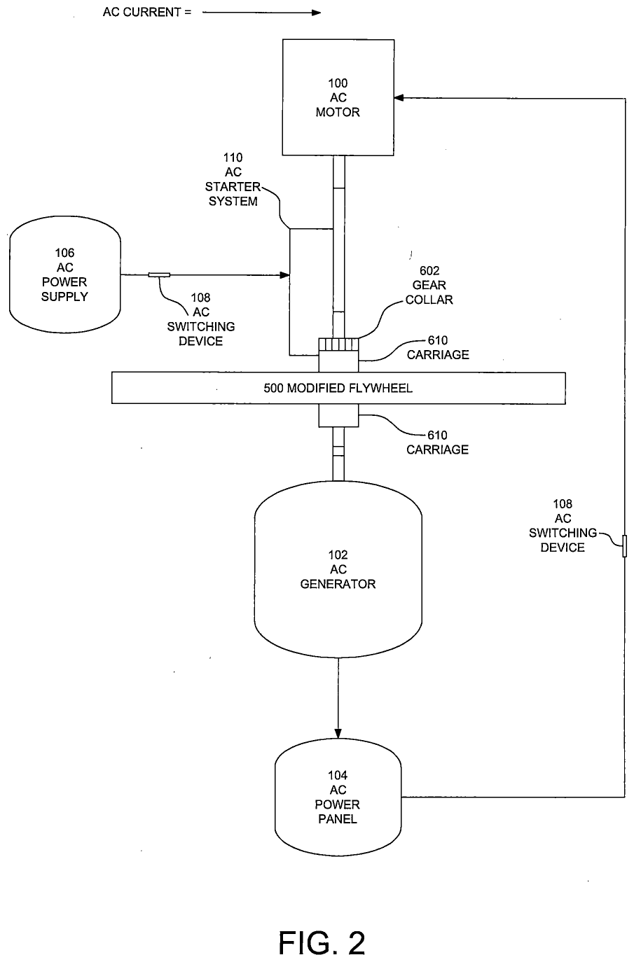

Referring to exemplary FIG. 2, a diagram and electrical flow chart of a TIES process wherein the result of said process may produce approximately 97,000 watts of usable electricity.

According to FIG. 2, an AC POWER SUPPLY 106 may be electrically connected by wire to an AC STARTER SYSTEM 110. Disposed within the wire between said AC POWER SUPPLY 106 and said AC STARTER SYSTEM 110 there may be an AC SWITCHING DEVICE 108 that may provide an option between an opened or closed electrical circuit. Said AC STARTER SYSTEM 110 may be configured by one skilled in the art to engage the GEAR COLLAR 602 in a similar fashion as an automobile starter engages an automobile flywheel until said automobile is started, at which point in time the components of the automobile starter may disengage the flywheel.

According to exemplary FIG. 2, a continuous duty AC MOTOR 100 rated at approximately 4 horsepower may be determined to be capable and suitable to be used in the TIES process and may be mechanically connected by a rigid sleeve to one end of a driveshaft, where the other end of said driveshaft may be mechanically connected by a rigid sleeve to the MODIFIED FLYWHEEL 500 (on the side of the MODIFIED FLYWHEEL 500 exemplifying the GEAR COLLAR 602).

According to exemplary FIG. 2, the remaining side of the MODIFIED FLYWHEEL 500 may be mechanically connected by one or more rigid sleeves and one or more driveshafts to the shaft of the AC GENERATOR 102.

According to exemplary FIG. 2, for explanatory purposes, the shaft of the continuous duty AC MOTOR 100 is directly mechanically connected to the rotor shaft of the AC GENERATOR 102. That is to say, for exemplary and explanatory purposes only, should the shaft of the continuous duty AC MOTOR 100 turn one revolution, the mechanically connected rotor of the AC GENERATOR 102 would also turn one revolution.

Further, for explanatory and exemplary purposes, a bearing system within a CARRIAGE 610 may be considered to be fashioned and configured by one skilled in the art in a manner where said bearing system and CARRIAGE 610, continuous duty AC MOTOR 100, AC GENERATOR, MODIFIED FLYWHEEL 500 and other aforementioned components may be securely and mechanically connected with a frame system, depending on the application of the selected TIES process and the configuration of the components used within the process. Such a configuration may allow for the MODIFIED FLYWHEEL 500 and other discussed components to freely rotate with resistance being from only the bearing systems and the air against the MODIFIED FLYWHEEL 500.

According to exemplary FIG. 2, one or more electrical output connection points of the AC GENERATOR 102 may be wired and electrically connected to one or more electrical input connection points of the AC POWER PANEL 104. Said AC POWER PANEL 104 may be wired and electrically connected from the electrical output connection points of the AC POWER PANEL 104 to the electrical input connection points of the continuous duty AC MOTOR 100. There may be an AC SWITCHING DEVICE 108 disposed in the wiring between said AC POWER PANEL 104 and said continuous duty AC MOTOR 100. Said AC SWITCHING DEVICE 108 may provide an option between either an opened or closed electrical circuit.

The aforementioned components and devices may be configured in a manner where stationary components and devices may have a rigid mechanical connection to a fashioned frame engineered by one skilled in the art, where said components and devices may be meticulously aligned to receive the rotating components. Said rotating components may be meticulously balanced by one skilled in the art prior to installation in the TIES process.

It may be presumed, for explanatory and exemplary purposes that one or more persons skilled in the various arts comprising this TIES process has verified all mechanical and electrical connections are secure, and that a manual rotation of the MODIFIED FLYWHEEL 500 was performed and had revealed no rotational obstructions.

Ensuring that the AC SWITCHING DEVICE 108 between the AC POWER PANEL 104 and the continuous duty AC MOTOR 100 is in the closed position allowing for the flow of electricity, the AC SWITCHING DEVICE 108 between the AC POWER SUPPLY 106 and the AC STARTER SYSTEM 110 may be moved to the closed position to allow for electricity to flow from said AC POWER SUPPLY 106 to said AC STARTER SYSTEM 110, where said AC STARTER SYSTEM 110 may engage with the GEAR COLLAR 602 and begin rotating the MODIFIED FLYWHEEL 500 and other components of this TIES process. At the point in time when the MODIFIED FLYWHEEL 500 reaches approximately 1800 RPM, the AC SWITCHING DEVICE 108 between the AC POWER SUPPLY 106 and the AC STARTER SYSTEM 110 may be moved to the opened position which may stop the flow of electricity to the AC STARTER SYSTEM 110 that may disengage from the GEAR COLLAR 602. Alternatively, and not exemplified, smaller electricity and mechanical energy TIES processes may not require the starting process explained and exemplified hereinbefore and hereinafter. As an example, a smaller system may be able to be started by the AC MOTOR 100 itself. One may be able to plug an AC high torque motor into a standard electrical receptacle that may allow the aforesaid AC MOTOR 100 to rotate the MODIFIED FLYWHEEL 500 to an approximate 1800 RPM, at which point in time said plug from the standard receptacle may be unplugged and then immediately plugged into an appropriate electrical receptacle of the AC GENERATOR 102 and/or AC POWER PANEL 104. This may allow for the MODIFIED FLYWHEEL 500 to continue to rotate at an approximate 1800 RPM. Whether the MODIFIED FLYWHEEL 500 is brought to the operational speed discussed hereinbefore and hereinafter by either starting process, neither would detract from the spirit and scope of the present invention.

The AC GENERATOR 102 may now be producing approximately 100,000 watts of electricity which may flow to the AC POWER PANEL 104. The AC GENERATOR 102 may be rotating at approximately 1800 RPM due to the approximate 440 foot pounds of rotational torque being applied to the shaft of the rotor.

Approximately 3000 watts of electricity may be reserved and transmitted to the continuous duty AC MOTOR 100 from the AC POWER PANEL 104 which may allow said continuous duty AC MOTOR 100 to perform its desired function of maintaining the approximate 1800 RPM of the MODIFIED FLYWHEEL 500.

The TIES process in the foregoing exemplified embodiment may be capable of producing approximately 97,000 watts of usable electricity for an undeterminable period of time, or until either the AC SWITCHING DEVICE 108 between the AC POWER PANEL 104 and the continuous duty AC MOTOR 100 is moved to the opened position which may not allow for the continued flow of electricity to maintain the operation of the continuous duty AC MOTOR 100, or some other unpredicted mechanical or electrical failure occurs.

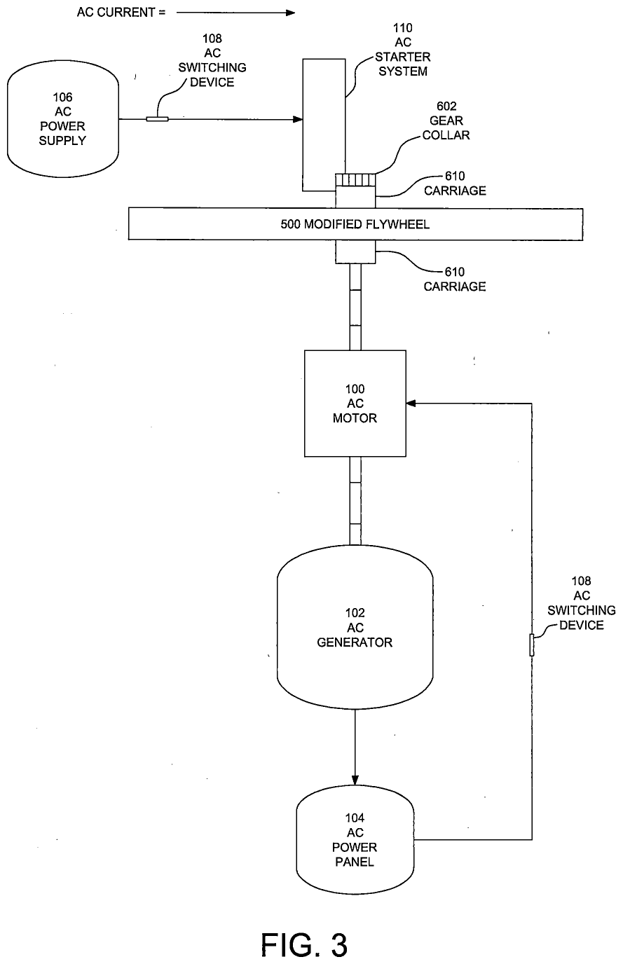

Referring to exemplary FIG. 3, a diagram and electrical flow chart of a TIES process wherein the result of said process may produce approximately 97,000 watts of usable electricity. The exemplary embodiment in FIG. 3 may have the same resultant effect as the exemplified embodiment in FIG. 2, in such, the exemplified embodiments reveal the versatility of the potential embodiments of the TIES processes which may produce a like result.

According to FIG. 3, an AC POWER SUPPLY 106 may be electrically connected by wire to an AC STARTER SYSTEM 110. Disposed within the wire between said AC POWER SUPPLY 106 and said AC STARTER SYSTEM 110 there may be an AC SWITCHING DEVICE 108 that may provide an option between an opened or closed electrical circuit. Said AC STARTER SYSTEM 110 may be configured by one skilled in the art to engage the GEAR COLLAR 602 in a similar fashion as an automobile starter engages a automobile flywheel until said automobile is started at which point in time the components of the automobile starter may disengage the flywheel.

According to exemplary FIG. 3, a dual shaft continuous duty AC MOTOR 100 rated at approximately 4 horsepower may be determined to be capable and suitable to be used in this TIES process and may be mechanically connected by the use of rigid sleeves and one or more driveshafts on one of the two shafts of the continuous duty AC MOTOR 100 to a MODIFIED FLYWHEEL 500, as exemplified in FIG. 3.

According to FIG. 3, the remaining shaft of the continuous duty AC MOTOR 100 may be connected by the use of rigid sleeves and one or more driveshafts to the shaft of the AC GENERATOR 102.

According to exemplary FIG. 3, for explanatory purposes, the shaft of the continuous duty AC MOTOR 100 is directly mechanically connected to the rotor shaft of the AC GENERATOR 102. That is to say, for exemplary and explanatory purposes only, should the shaft of the continuous duty AC MOTOR 100 turn one revolution, the mechanically connected rotor of the AC GENERATOR 102 would also turn one revolution.

According to exemplary FIG. 3, a bearing system within a CARRIAGE 610 may be considered to be fashioned and configured in a manner where said bearing system and CARRIAGE 610, continuous duty AC MOTOR, 100, AC GENERATOR 102, MODIFIED FLYWHEEL 500 and other aforementioned components may be securely and mechanically connected to a frame system, depending on the application of the chosen TIES process and the configuration of components used within the process. Such a configuration may allow for the MODIFIED FLYWHEEL 500 and other discussed components to freely rotate with resistance being from only the bearing systems and the air against the MODIFIED FLYWHEEL 500.

According to exemplary FIG. 3, one or more electrical output connection points of the AC GENERATOR 102 may be wired and electrically connected to one or more electrical input connection points of the AC POWER PANEL 104. Said AC POWER PANEL 104 may be wired and electrically connected from the electrical output connection points of the AC POWER PANEL 104 to the electrical input connection points of the continuous duty AC MOTOR 100. There may be an AC SWITCHING DEVICE 108 disposed in the wiring between said AC POWER PANEL 104 and said continuous duty AC MOTOR 100. Said AC SWITCHING DEVICE 108 may provide an option between either an opened or closed electrical circuit.

The aforementioned components and devices may be configured in a manner where stationary components and devices may have a rigid mechanical connection to a fashioned frame engineered by one skilled in the art, where said components and devices may be meticulously aligned to receive the rotating components. Said components may be. Meticulously balanced by one skilled in the art prior to the installation in the TIES process.

It may be presumed, for explanatory and exemplary purposes that one or more persons skilled in the various arts comprising this TIES process has verified all mechanical and electrical connections are secure, and that a manual rotation of the MODIFIED FLYWHEEL 500 was performed and revealed no rotational obstructions.

Ensuring that the AC SWITCHING DEVICE 108 between the AC POWER PANEL 104 and the continuous duty AC MOTOR 100 is in the closed position allowing for the flow of electricity, the AC SWITCHING DEVICE 108 between the AC POWER SUPPLY 106 and the AC STARTER SYSTEM 110 may be moved to the closed position to allow for electricity to flow from said AC POWER SUPPLY 106 to said AC STARTER SYSTEM 110, where said AC STARTER SYSTEM 110 may engage with the GEAR COLLAR 602 and begin rotating the MODIFIED FLYWHEEL 500 and other components of this TIES process. At the point in time when the MODIFIED FLYWHEEL 500 reaches approximately 1800 RPM, the AC SWITCHING DEVICE 108 between the AC POWER SUPPLY 106 and the AC STARTER SYSTEM 110 may be moved to the opened position which may stop the flow of electricity to the AC STARTER SYSTEM 110 that may disengage from the GEAR COLLAR 602. Alternatively, and not exemplified, smaller electricity and mechanical energy TIES processes may not require the starting process explained in paragraph [0140].

The AC GENERATOR 102 may now be producing approximately 100,000 watts of electricity which may flow to the AC POWER PANEL 104. The AC GENERATOR 102 rotor may be rotating at approximately 1800 RPM due to the approximate 440-foot pounds of rotational torque being applied to the shaft of the rotor.

Approximately 3000 watts of electricity may be reserved and transmitted to the continuous duty AC MOTOR 100 from the AC POWER PANEL 104 which may allow said continuous duty AC MOTOR 100 to perform its desired function of maintaining the approximate 1800 RPM of the MODIFIED FLYWHEEL 500.

The TIES process in the foregoing exemplified embodiment may be capable of producing approximately 97,000 watts of usable electricity for an undeterminable period of time, or until either the AC SWITCHING DEVICE 108 between the AC POWER PANEL 104 and the continuous duty AC MOTOR 100 is moved to the opened position which may not allow for the continued flow of electricity to maintain the operation of the continuous duty AC MOTOR 100, or some other unpredicted mechanical or electrical failure occurs.

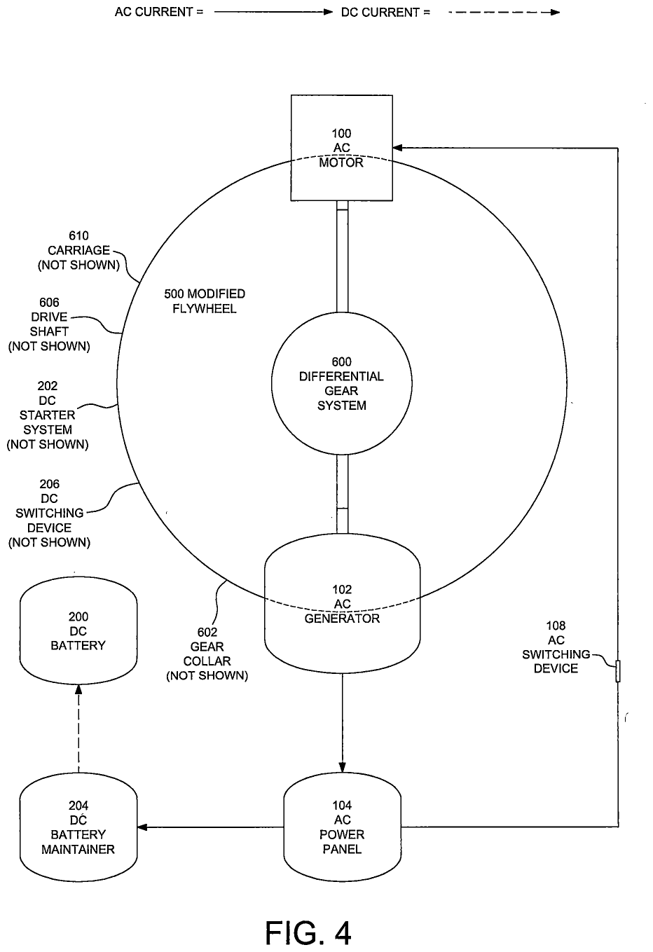

Referring to exemplary FIG. 4, a diagram and electrical flow chart chart of a TIES process wherein the result of said process may produce approximately 97,000 watts of usable electricity. The exemplary embodiment in FIG. 4 may have the same resultant effect as the exemplified embodiments which reveal the versatility of the potential embodiments of the TIES processes which may produce a like result.

According to FIG. 4, a DC BATTERY 200 may be electrically connected by wire to a DC STARTER SYSTEM 202 (not shown). Disposed within the wire between said DC BATTERY 200 and said DC STARTER SYSTEM 202 may be a DC SWITCHING DEVICE 206 (not shown) that may provide an option between an opened or closed electrical circuit. Said DC STARTER 202 may be configured by one skilled in the art to engage the GEAR COLLAR 602 (not shown) in a similar fashion as an automobile starter may engage an automobile flywheel until said automobile is started, at which point in time the components of the automobile starter may disengage the flywheel.

According to exemplary FIG. 4, there is an addition of a gear system not exemplified or embodied in other figures. The exemplified embodiment configuration of FIG. 4 may allow the MODIFIED FLYWHEEL 500 to be set in a horizontal position for specific applications of a specific TIES process. Further, FIG. 4 may have a continuous duty AC MOTOR 100 rated at approximately 4 horsepower determined to be capable and suitable to be used and may be mechanically connected by the use of one or more rigid sleeves and one or more driveshafts to a DIFFERENTIAL GEAR SYSTEM 600, as exemplified in FIG. 4.

According to exemplary FIG. 4, the remaining driveshaft of the DIFFERENTIAL GEAR SYSTEM 600 may be mechanically connected by the use of one or more rigid sleeves and one or more driveshafts to the shaft of the AC GENERATOR 102, as exemplified in FIG. 4.

According to exemplary FIG. 4, for explanatory purposes only, the shaft of the continuous duty AC MOTOR 100 is directly mechanically connected to the rotor shaft of the AC GENERATOR. That is to say, for exemplary and explanatory purposes only, should the shaft of the continuous duty AC MOTOR 100 turn one revolution, the mechanically connected rotor of the AC GENERATOR 102 would also turn one revolution.

According to exemplary FIG. 4, a bearing system within a CARRIAGE 610 (not shown) may be considered to have been fashioned and configured in a manner where said bearing system and CARRIAGE 610 (not shown), continuous duty AC MOTOR 100, AC GENERATOR 102, MODIFIED FLYWHEEL 500 and other aforementioned components may have been securely and mechanically connected with a frame system, depending on the application of the chosen TIES process and the configuration of the components within the process. Such a configuration may allow for the MODIFIED FLYWHEEL 500 and other discussed components to freely rotate with resistance from only the gears of the DIFFERENTIAL GEAR SYSTEM 600, the bearing systems and the air against the MODIFIED FLYWHEEL 500 when revolving.

According to exemplary FIG. 4, one or more electrical output connection points of the AC GENERATOR 102 may be wired and electrically connected to one or more electrical input connection points of the AC POWER PANEL 104. Said AC POWER PANEL 104 may be wired and electrically connected from the electrical output connection points of the AC POWER PANEL 104 to one or more electrical input connection points of the continuous duty AC MOTOR 100. There may be an AC SWITCHING DEVICE 108 disposed in the wiring between said AC POWER PANEL 104 and said continuous duty AC MOTOR 100. Said AC SWITCHING DEVICE 108 may provide an option between either an opened of closed electrical circuit.

According to exemplary FIG. 4, one or more electrical output connection points of the AC GENERATOR 102 may be wired and electrically connected to one or more electrical input connection points of a DC BATTERY MAINTAINER 204. Said DC BATTERY MAINTAINER 204 electrical output connection points may be wired and electrically connected to the electrical input connection points of the DC BATTERY 200.

The aforementioned components and devices exemplified in FIG. 4 may be configured in a manner where stationary components and devices may have a rigid mechanical connection to a fashioned frame engineered by one skilled in the art, where said components and devices may be meticulously aligned to receive the rotating components. Said rotating components may be meticulously balanced by one skilled in the art prior to installation in the TIES process.

It may be presumed, for explanatory and exemplary purposes that one or more persons skilled in the various arts comprising this TIES process has verified all mechanical and electrical connections are secure, and that a manual rotation of the MODIFIED FLYWHEEL 500 was performed and had revealed no rotational obstructions.

Ensuring that the AC SWITCHING DEVICE 108 between the AC POWER PANEL 104 and the continuous duty AC MOTOR 100 is in the closed position allowing for the flow of electricity, the DC SWITCHING DEVICE 206 (not shown) between the DC BATTERY 200 and the DC STARTER SYSTEM 202 (not shown) may be moved to the closed position allowing for electricity to flow from said DC BATTERY 200 to the DC STARTER SYSTEM 202, where said DC STARTER SYSTEM 202 may engage with the GEAR COLLAR 602 (not shown) and begin rotating the MODIFIED FLYWHEEL 500 and other components of this TIES process. At the point in time when the MODIFIED FLYWHEEL 500 reaches approximately 1800 RPM, the DC SWITCHING DEVICE 206 between the DC BATTERY 200 and the DC STARTER SYSTEM 202 may be moved to the opened position which may stop the flow of electricity to the DC STARTER SYSTEM 202 that may disengage from the GEAR COLLAR 602. Alternatively, and not exemplified, smaller electricity and mechanical energy TIES processes may not require the starting process explained hereinbefore and hereinafter, as explained in paragraph [0140].

The AC GENERATOR 102 may now be producing approximately 100,000 watts of electricity which may flow to the AC POWER PANEL 104. The AC GENERATOR 102 rotor may be rotating at approximately 1800 RPM due to the approximate 440-foot pounds of rotational torque being applied to the shaft of the rotor.

Approximately 3000 watts of electricity may be reserved and transmitted to the continuous duty AC MOTOR 100, which may allow said continuous duty AC MOTOR 100 to perform its desired function of maintaining the approximate 1800 RPM of the MODIFIED FLYWHEEL 500. Further, an undetermined, however, minimal amount of electricity may be transmitted from the AC POWER PANEL 104 to the DC BATTERY MAINTAINER 204 in order to maintain the DC BATTERY 200 system at its peak performance level for future use.

The TIES process in the foregoing exemplified embodiment of FIG. 4 may be capable of producing approximately 97,000 watts of usable electricity for an undetermined period of time, or until the AC SWITCHING DEVICE 108 between the AC POWER PANEL 104 and the continuous duty AC MOTOR 100 is moved to the opened position which may not allow for the continued flow of electricity to maintain the operation of the continuous duty AC MOTOR 100, or some other unpredicted electrical or mechanical failure occurs.

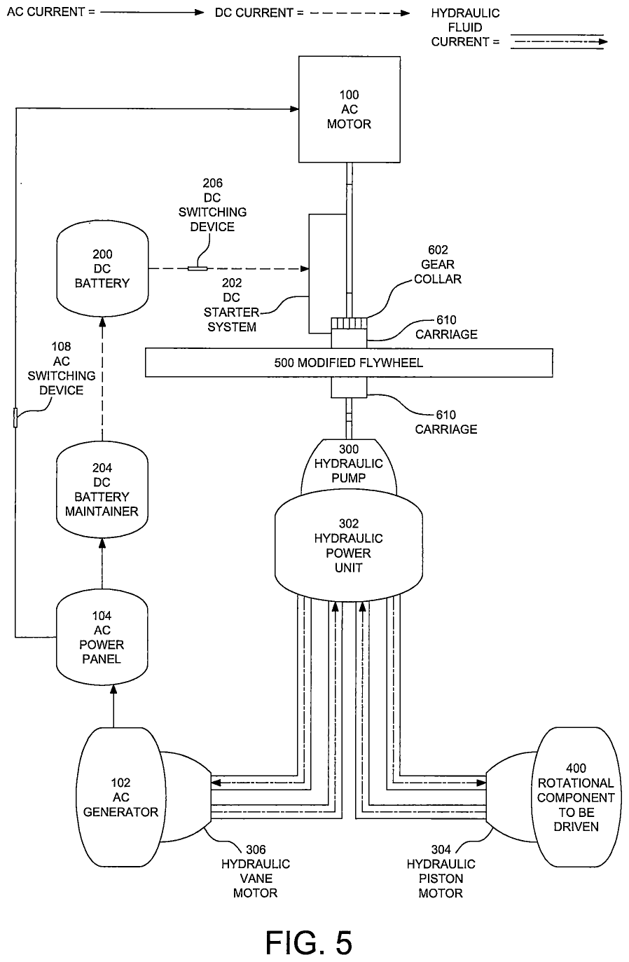

Referring now to exemplary FIG. 5, a diagram of an electrical and hydraulic flow chart of a TIES process.

According to FIG. 5, a DC BATTERY 200 may be electrically connected by wire to a DC STARTER SYSTEM 202. Disposed within the wire between said DC BATTERY 200 and said DC STARTER SYSTEM 202 there may be a DC SWITCHING DEVICE 206 that may provide an option between either an opened or closed electrical circuit. Said DC STARTER SYSTEM 202 may be configured by one skilled in the art to engage the GEAR COLLAR 602 in a similar fashion as an automobile starter system engages with an automobile flywheel until said automobile is started, at which point in time the components of the automobile starter may disengage the flywheel.

According to exemplary FIG. 5, a continuous duty AC MOTOR 100 rated at approximately 4 horsepower may be determined to be capable and suitable to be used and may be mechanically connected by the use of one or more rigid sleeves and one or more driveshafts to a MODIFIED FLYWHEEL 500, as exemplified in FIG. 5.

According to exemplary FIG. 5, a MODIFIED FLYWHEEL 500 may be mechanically connected by the use of one or more rigid sleeves and one or more driveshafts to the shaft of the HYDRAULIC PUMP 300.

According to exemplary FIG. 5, for exemplary purposes, the shaft of the continuous duty AC MOTOR 100 is directly mechanically connected to the shaft of the HYDRAULIC PUMP 300. That is to say, for exemplary and explanatory purposes only, should the shaft of the continuous duty AC MOTOR 100 turn one revolution, the mechanically connected shaft of the HYDRAULIC PUMP 300 may also turn one revolution.

Further, for explanatory and exemplary purposes, a bearing system within a CARRIAGE 610 shall be considered to be fashioned and configured in a manner where said bearing system and CARRIAGE 610, continuous duty AC MOTOR 100, HYDRAULIC PUMP 300, AC GENERATOR 102, HYDRAULIC POWER UNIT 302, MODIFIED FLYWHEEL 500, BATTERY MAINTAINER 204 and other exemplified components may be secured and mechanically connected to a frame system, depending on the specific application of the selected TIES process. Such a configuration may allow for the MODIFIED FLYWHEEL 500 and other discussed components to freely rotate with resistance from only the bearing systems and the air against the MODIFIED FLYWHEEL 500.

According to exemplary FIG. 5, one hydraulic outlet port of the HYDRAULIC POWER UNIT 302 is hydraulically connected by the use of capable and suitable hydraulic lines and hydraulic fittings to the hydraulic inlet port of the HYDRAULIC VANE MOTOR 306. The hydraulic outlet port of said HYDRAULIC VANE MOTOR 306 may be hydraulically connected to the return line inlet port of the HYDRAULIC POWER UNIT 302 by the use of capable and suitable hydraulic lines and hydraulic fittings.

According to exemplary FIG. 5, an AC GENERATOR 102 may be mechanically connected to the HYDRAULIC VANE MOTOR 306. Said AC GENERATOR 102 in this exemplary embodiment may be rated at approximately 10,000 watts of electricity being generated at approximately 1800 RPM, and said HYDRAULIC VANE MOTOR 306 may be rated at approximately 140 foot pounds of torque at approximately 1800 RPM.

According to exemplary FIG. 5, a second hydraulic outlet port of the HYDRAULIC POWER UNIT 302 may be hydraulically connected by the use of capable and suitable hydraulic lines and hydraulic fittings to the hydraulic inlet port of the HYDRAULIC PISTON MOTOR 304. The hydraulic outlet port of said HYDRAULIC PISTON MOTOR 304 may be hydraulically connected to the return line inlet port of the HYDRAULIC POWER UNIT 302 by the use of capable and suitable hydraulic lines and hydraulic fittings.

According to exemplary FIG. 5, a ROTATIONAL COMPONENT TO BE DRIVEN 400 may be mechanically connected to the HYDRAULIC PISTON MOTOR 304. Said HYDRAULIC PISTON MOTOR 304 in this exemplary embodiment may be rated at approximately 250 foot pounds of torque at approximately 1800 RPM, approximately 500 foot pounds of torque at approximately 900 RPM, or approximately 750 foot pounds of torque at approximately 450 RPM with the implementation of gear reducers.

According to exemplary FIG. 5, one or more electrical output connection points of the AC GENERATOR 102 may be wired and electrically connected to one or more electrical input connection points of the AC POWER PANEL 104.

According to exemplary FIG. 5, one or more electrical output connection points of the AC POWER PANEL 104 may be wired and electrically connected to one or more electrical input connection points of the DC BATTERY MAINTAINER 204.

According to exemplary FIG. 5, one or more electrical output connection points of the DC BATTERY MAINTAINER 204 may be wired and electrically connected to one or more electrical input connection points of the DC BATTERY 200 system.

According to exemplary FIG. 5, one or more electrical output connection points of the AC POWER PANEL 104 may be wired and electrically connected to one or more electrical input connection points of the continuous duty AC MOTOR. There may be an AC SWITCHING DEVICE 108 disposed in the wiring between said AC POWER PANEL 104 and said continuous duty AC MOTOR 100. Said AC SWITCHING DEVICE 108 may provide an option between either an opened or closed electrical circuit.

The aforementioned components and devices may be configured in a manner where stationary components and devices may have a rigid mechanical connection to a fashioned frame system engineered by one skilled in the art, where said components and devices may be meticulously aligned to receive the rotating components. Said rotating components may be meticulously balanced by one skilled in the art prior to the installation in this TIES process.

It may be presumed, for explanatory and exemplary purposes only, that one or more persons skilled in the various arts comprising this TIES process has verified that all mechanical, hydraulic and electrical connections are secure, and that a manual rotation of the MODIFIED FLYWHEEL 500 was performed and had revealed no rotational obstructions.

Ensuring that the AC SWITCHING DEVICE 108 between the AC POWER PANEL 104 and the continuous duty AC MOTOR 100 is in the closed position allowing for the flow of electricity, the DC SWITCHING DEVICE 206 between the DC BATTERY 200 system and the DC STARTER SYSTEM 202 may be moved to the closed position in order to allow electricity to flow from the DC BATTERY 200 system to said DC STARTER SYSTEM 202, where said DC STARTER SYSTEM 202 may engage with the GEAR COLLAR 602 and begin rotating the MODIFIED FLYWHEEL and other components of this TIES process. At the point in time when the MODIFIED FLYWHEEL 500 reaches approximately 1800 RPM, the DC SWITCHING DEVICE 206 between the DC BATTERY 200 system and the DC STARTER SYSTEM 202 may be moved to the opened position which may stop the flow of electricity to the DC STARTER SYSTEM 202 that may then disengage from the GEAR COLLAR 602. Alternatively, and not exemplified, smaller electricity and mechanical energy TIES processes may not require the starting process explained hereinbefore and hereinafter as explained in paragraph [0140].

The HYDRAULIC POWER UNIT 302 may now be producing the necessary hydraulic pressure in the hydraulic system to operate

The HYDRAULIC PISTON MOTOR 304 and the HYDRAULIC VANE MOTOR 306 at the necessary approximate 1800 RPM in order to achieve the desired result. The HYDRAULIC PISTON MOTOR 304 may be producing the torque and RPM discussed hereinbefore in order to propel the UNDISCLOSED DEVICE TO BE DRIVEN. The HYDRAULIC VANE MOTOR 306 may be producing the necessary approximate 1800 RPM to the mechanically connected AC GENERATOR 102 in order to produce approximately 10,000 watts of electricity.

The HYDRAULIC PUMP 300 may be producing the necessary pressure for the aforementioned hydraulic motors in order to perform at their capacity due to the approximate 440-foot pounds of rotational torque being applied to the HYDRAULIC PUMP 300 by the MODIFIED FLYWHEEL 500.

Approximately 3000 watts of electricity may be reserved and transmitted to the continuous duty AC MOTOR 100, that may allow said continuous duty AC MOTOR 100 to perform its desired function of maintaining the approximate 1800 RPM to the MODIFIED FLYWHEEL 500. Further, an undetermined, however, minimal amount of electricity may be reserved and transmitted from the AC POWER PANEL 104 to the DC BATTERY MAINTAINER 204 in order to maintain an optimal charge on the DC BATTERY 200 system.

The TIES process in the foregoing exemplified embodiment may be capable of producing a varying amount of torque and RPM through the use of gear reducers. Further, the TIES process in the foregoing exemplified embodiment may be capable of producing approximately 7000 watts of usable electricity simultaneously with the hydraulic motors discussed hereinbefore for an undeterminable period of time, or until the AC SWITCHING DEVICE 108 between the AC POWER PANEL 104 and the continuous duty AC MOTOR 100 is moved to the opened position which may not allow for the continuous flow of electricity to maintain the operation of the continuous duty AC MOTOR, or some other unpredictable mechanical, hydraulic or electrical failure occurs.

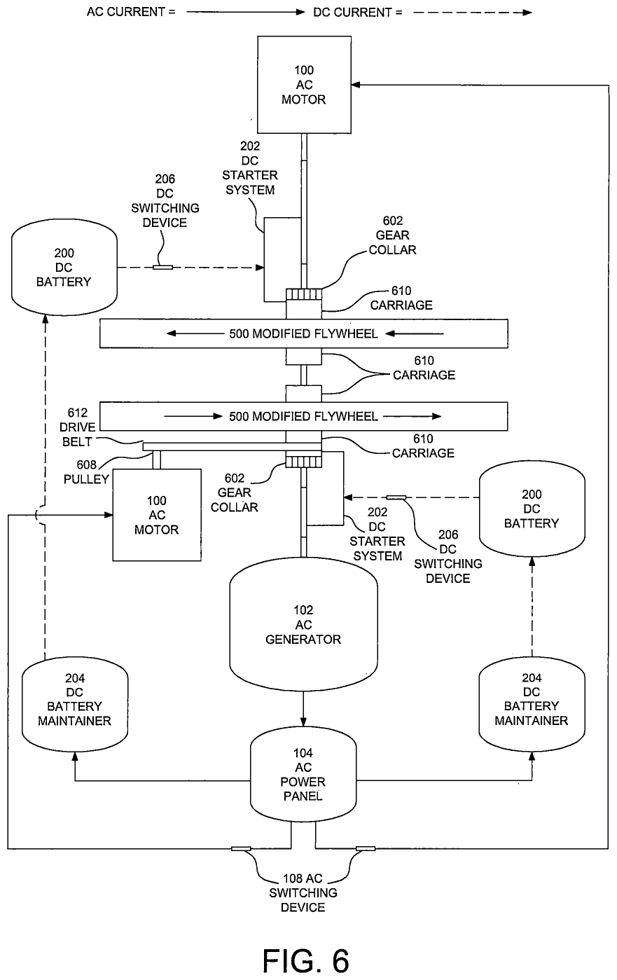

Referring to exemplary FIG. 6, a diagram and electrical flow chart wherein the result of said process may produce approximately 94,000 watts of usable electricity. It is noteworthy that in certain applications the TIES processes, specifically in mobile applications, that it may become necessary to counteract the force that may be produced by the MODIFIED FLYWHEEL 500 when rotating. In the process exemplified hereinafter, said force may be counteracted by the addition of a second, equally weighted, MODIFIED FLYWHEEL 500.

According to exemplary FIG. 6, each DC BATTERY 200 system may be electrically connected by wire to each of the exemplary DC STARTER SYSTEMS 202. Disposed within the wires between said DC BATTERY 200 systems and said DC STARTER SYSTEMS 202 components there may be a DC SWITCHING DEVICE 206 that may provide an option between an opened or closed electrical circuit. Each DC STARTER SYSTEM 202 component may be configured by one skilled in the art to engage each GEAR COLLAR 602 in a similar fashion as an automobile starter engages an automobile flywheel until said automobile is started, at which point in time the components of the automobile starter may disengage the flywheel.

According to exemplary FIG. 6, a continuous duty AC MOTOR 100 rated at approximately 4 horsepower may be determined to be capable and suitable to be used and may be mechanically connected to a MODIFIED FLYWHEEL 500 by the use of one or more rigid sleeves and one or more driveshafts.

According to exemplary FIG. 6, a continuous duty AC MOTOR 100 rated at approximately 4 horsepower may be determined to be capable and suitable to be used in this exemplified embodiment of a TIES process and may be mechanically connected to by the use of a PULLEY 608 and DRIVE BELT 612 to a second equally weighted MODIFIED FLYWHEEL 500, as exemplified in FIG. 6.

According to exemplary FIG. 6, the two MODIFIED FLYWHEELS 500 may be on the same shaft and/or driveshaft, however, the second MODIFIED FLYWHEEL 500 utilizing the PULLEY 608 and DRIVE BELT 612 system may not be mechanically connected to the same shaft and/or driveshaft as is the first MODIFIED FLYWHEEL 500. That is to say, the MODIFIED FLYWHEEL 500 utilizing the PULLEY 608 and DRIVE-BELT 612 system may have an independent bearing system within a housing that allows for said MODIFIED FLYWHEEL 500 to rotate in an opposite direction than the shaft and/or driveshaft used as a component of the driver of the AC GENERATOR 102. Thereby, the MODIFIED FLYWHEEL 500 utilizing the PULLEY 608 and DRIVE-BELT 612 system may not have an effect on the shaft and/or driveshaft as it is not mechanically connected in such a fashion as the MODIFIED FLYWHEEL 500 is mechanically connected to the continuous duty AC MOTOR 100.

For exemplary purposes, should the shaft of the continuous duty AC MOTOR 100 that is mechanically connected to the shaft of the MODIFIED FLYWHEEL 500 that is not utilizing the PULLEY 608 and DRIVE-BELT 612 system turn one revolution, the shaft mechanically connected to the shaft or the AC GENERATOR 102 rotor would also turn one revolution. Meanwhile, the MODIFIED FLYWHEEL 500 utilizing the PULLEY 608 and DRIVE-BELT 612 system would not turn at all, until it is put into operation to do so, explained and exemplified forthcoming.

According to exemplary FIG. 6, the continuous duty AC MOTOR 100 and MODIFIED FLYWHEEL 500 that are mechanically connected to the AC GENERATOR 102 by the exemplified rigid sleeves and driveshafts may revolve in one direction at an exemplified approximate 1800 RPM, while the MODIFIED FLYWHEEL 500 utilizing the PULLEY 608 and DRIVE-BELT 612 system may revolve in a opposite direction at an exemplified approximate 1800 RPM.

Further, for exemplary and explanatory purposes, a plurality of bearing systems within a CARRIAGE 610 may be considered to be fashioned and configured by one skilled in the art in a manner where said bearing systems and CARRIAGES 610, two continuous duty AC MOTORS 100, two equally weighted MODIFIED FLYWHEELS 500, the AC GENERATOR 102 and other discussed components may be securely and mechanically connected with a frame system that, depending of the application of the chosen TIES process and the configuration of components used within the process. Such a configuration may allow for the aforesaid MODIFIED FLYWHEELS 500 and other discussed components to freely rotate with minimal resistance.

According to exemplary FIG. 6, one or more electrical output connection points of the AC GENERATOR 102 may be wired and electrically connected to one or more electrical input connection points of the AC POWER PANEL 104. Said AC POWER PANEL may have a plurality of output connection points wired and electrically connected to the electrical input connection points of each continuous duty AC MOTOR 100. There may be an AC SWITCHING DEVICE 108 disposed in the wiring between the AC POWER PANEL 104 and each continuous duty AC MOTOR 100. Each AC SWITCHING DEVICE 108 may provide an option between either an opened or closed electrical circuit.

According to exemplary FIG. 6, one or more electrical output connection points of the AC POWER PANEL 104 may be wired and electrically connected to the electrical input connection points of each DC BATTERY MAINTAINER 204. Each of said DC BATTERY MAINTAINERS 204 may be wired and electrically connected by one or more of their electrical output connection points to the electrical input connection points of each DC BATTERY 200 system.

The aforementioned components and devices may be configured in such a manner where stationary components and devices may have a rigid mechanical connection to a fashioned frame system engineered by one skilled in the art, where said components and devices may be meticulously aligned to receive the rotating components. Said rotating components may be meticulously balanced by one skilled in the art prior to the installation in this TIES process.

It may be presumed, for explanatory and exemplary purposes that one or more persons skilled in the various arts comprising this TIES process has verified all mechanical and electrical connections are secure and that a manual rotation of each of the MODIFIED FLYWHEELS 500 was performed and had revealed no rotational obstructions.

Ensuring that each AC SWITCHING DEVICE 108 between the AC POWER PANEL 104 and each exemplified continuous duty AC MOTOR 100 are in the closed position allowing for the flow of electricity, each DC SWITCHING DEVICE 206 between each of the exemplified DC BATTERY 200 systems and each exemplified DC STARTER SYSTEMS 202 may be moved to the closed position to allow for electricity to flow from each DC BATTERY 200 system to each DC STARTER SYSTEM 202 where each DC STARTER SYSTEM 202 may engage with each exemplified GEAR COLLAR 602 and begin rotating said MODIFIED FLYWHEELS 500 and other components of this TIES process. At the point in time when the DC STARTER SYSTEMS 202 have engaged with each of the GEAR COLLARS 602 of each MODIFIED FLYWHEELS 500 and said MODIFIED FLYWHEELS 500 achieve approximately 1800 RPM, each of the aforesaid DC SWITCHING DEVICES 206 may be moved to the opened positions which may stop the flow of electricity to each of the DC STARTER SYSTEMS 202 that may then disengage from the GEAR COLLARS 602. Alternatively, and not exemplified, smaller electricity and mechanical energy TIES processes may not require the starting process as explained in paragraph [0140].

The exemplified AC GENERATOR 102 in FIG. 6 may now be producing approximately 100,000 watts of electricity which may flow to the AC POWER PANEL 104. The AC GENERATOR 102 rotor may be rotating at approximately 1800 RPM due to the approximate 440-foot pounds of rotational torque being applied to the shaft of the rotor by the MODIFIED FLYWHEEL 500. Further, any negative reaction by the force of said MODIFIED FLYWHEEL 500 may be neutralized by the force of the second equally weighted MODIFIED FLYWHEEL 500 rotating at approximately 1800 RPM in the opposite direction.

Approximately 3000 watts of electricity may be reserved and transmitted to each of the continuous duty AC MOTORS 100, which may allow each continuous duty AC MOTOR 100 to perform its desired function of maintaining approximately 1800 RPM to each of the MODIFIED FLYWHEELS 500. Further, an undetermined, however, minimal amount of electricity may be reserved and transmitted from the AC POWER PANEL 104 to each of the DC BATTERY MAINTAINERS 204 in order to maintain an optimal charge of the DC BATTERY 200 systems.

The TIES process in the foregoing exemplified embodiment may be capable of producing approximately 94,000 watts of usable electricity for an undeterminable period of time, or until each of the AC SWITCHING DEVICES 108 between the AC POWER PANEL 104 and each of the continuous duty AC MOTORS 100 are moved to the opened position which may not allow for the continued flow of electricity to maintain the operation of each of the continuous duty AC MOTORS 100, or some other unpredicted mechanical or electrical failure occurs.

As has been previously discussed, the exemplified embodiments relating to the present invention depict extremely limited examples of the versatility and various configurations that are possible with the discussed components of the TIES processes. They are not to be construed as limiting in any manner. Polar opposite, the configuration of the components that may comprise an exemplified TIES process may be designed for immediate modifications and expansions using materials discussed and not discussed hereinbefore.

What is claimed is:

1. a means of generating usable amounts of electricity using a process that does not rely on any known fuel sources and/or alternative energy sources. A process comprising the steps of, not necessarily in any particular order, at a minimum:
1) determining the approximate amount of electricity to be generated for the given application of the Trident Independent Energy System, then utilizing the manufacturers specification on the selected capable and suitable one or more AC generator(s) to determine the resistance (nm) in the magnetic field between the stator and the rotor when the one or more AC generators are operating at full capacity. That is to say, at full load, as explained and exemplified hereinbefore;
2) having determined the resistance in the magnetic field between the stator and the rotor on the one or more selected AC generator(s) when operating at full capacity, having one skilled in the art engineer one or more modified flywheel(s) in a like manner as explained and exemplified hereinbefore that will be capable and suitable to counteract the resistance of said magnetic field of the one or more AC generator(s) when operating at full capacity, where said one or more modified flywheel(s) will perform in a like manner as explained and exemplified hereinbefore;
3) having one skilled in the art, if necessary engineer one or more AC starter system(s) that will be capable and suitable to start the given application of the Trident Independent Energy System process by rotating the one or more modified flywheel(s) to the desired RPM in a like manner as explained and exemplified hereinbefore;
4) having one or more available AC power supplies as explained and exemplified hereinbefore for the purpose of activating the starting system of the given application of the Trident Independent Energy Systems process;
5) having one or more AC continuous duty motor(s) that are capable and suitable for the given application of the Trident Independent Energy System process as explained and exemplified hereinbefore;
6) having one or more driveshaft(s) that are capable and suitable to be used in the given application of the Trident Independent Energy System process as explained and exemplified hereinbefore;
7) having a plurality of bearing systems disposed in a capable and suitable manner within the given application of the Trident Independent Energy System process as explained and exemplified hereinbefore;
8) having one or more AC power panel(s) that are capable and suitable to be used within the given application of the Trident Independent Energy System process as explained and exemplified hereinbefore;
9) having an undeterminable quantity of capable and suitable wire for the necessary electrical connections of the given application of the Trident Independent Energy System process as explained and exemplified hereinbefore;
10) having one or more AC switching device(s) disposed within the electrical wiring in a capable and suitable manner for the given application of the Trident Independent Energy System process as explained and exemplified hereinbefore;
11) having an undeterminable structural frame system, if required, that is capable and suitable to securely support the components and devices of the given application of the Trident Independent Energy System process as explained and exemplified hereinbefore;
12) ensuring that the shaft(s) of the one or more AC continuous duty motor(s) are mechanically connected to the one or more modified flywheel(s) for the given application of the Trident Independent Energy System process in a like manner as explained and exemplified hereinbefore;
13) ensuring that the shaft(s) of the one or more AC generator(s) is mechanically connected to the one or more modified flywheel(s) for the given application of the Trident Independent Energy System process in a like manner as explained and exemplified hereinbefore;
14) ensuring that the AC starter system(s) have been configured and engineered in a capable and suitable manner for the given application of the Trident Independent Energy System process that is able to engage the one or more modified flywheel(s), or the like, in a like manner as explained and exemplified hereinbefore;
15) ensuring that the wiring of the selected components and devices of the given application of the Trident Independent Energy System process are connected in a like manner as explained and exemplified hereinbefore; and
16) ensuring that the selected components and devices of the given application of the Trident Independent Energy System process have been assembled and secured for said given application in a like manner as explained and exemplified hereinbefore, said given application of the Trident Independent Energy System process may be started as explained and exemplified hereinbefore where the resultant effect is generating electricity in a manner as described in the forthcoming abstract

2. a process of generating usable amounts of mechanical energy and electricity using a process that does not rely on any known fuel sources and/or known alternative energy sources. A process comprising the steps of, not necessarily in any particular order, at a minimum:
1) determining the amount of resistance of the one or more capable and suitable hydraulic pump(s) that are necessary to produce the desired results of the one or more hydraulic motor(s) used as driver(s) for one or more unspecified component(s) to be driven, utilizing the manufacturers specifications of the one or more hydraulic pump(s) to determine the rotational torque necessary to counteract said resistance of the one or more hydraulic pump(s) in the given application of the Trident Independent Energy System process in a like manner as explained and exemplified hereinbefore;
2) having determined the resistance of the one or more hydraulic pump(s) used for the given application of the Trident Independent Energy System process operating at full capacity, having one skilled in the art engineer one or more modified flywheel(s) in a like manner as explained and exemplified hereinbefore that are capable and suitable to counteract the resistance of the shaft(s) of the one or more hydraulic pump(s) used in said given application operating at full capacity, where the one or more modified flywheel(s) performs in a like manner as explained and exemplified hereinbefore;
3) having one skilled in the art, if necessary, engineer one or more AC starter system(s) that will be capable and suitable to start the given application of the Trident Independent Energy System process by rotating the one or more flywheel(s) to the desired RPM of the components in a like manner as explained and exemplified hereinbefore;
4) having one or more available AC power supplies as explained and exemplified hereinbefore for the purpose of activating the starting system of the given application of the Trident independent Energy System process;
5) having one e given application of the Trident Independent Energy System process as explained and exemplified hereinbefore;
6) having one or more AC generator(s) that is capable and suitable of providing a sufficient amount of electricity to the one or more AC continuous duty motor(s) used in the given application of the Trident Independent Energy System process as explained and exemplified hereinbefore;
7) having a hydraulic power unit that is capable and suitable to be hydraulically connected by hydraulic lines with one or more selected hydraulic motor(s) that are capable and suitable for the given application of the Trident Independent Energy System process as explained and exemplified hereinbefore;
8) having one or more driveshaft(s) that are capable and suitable to be used in the given application of the Trident Independent Energy Systems process as explained and exemplified hereinbefore;
9) having a plurality of bearing systems disposed in a capable and suitable manner within the given application of the Trident Independent Energy System process and explained and exemplified hereinbefore;
10) having one or more AC power panel(s) that are capable and suitable to be used within the given application of the Trident Independent Energy System process as explained and exemplified hereinbefore;
11) having an undeterminable quantity of capable and suitable wire and hydraulic line with capable and suitable electrical and hydraulic fitting for the electrical and hydraulic connections of the given application of the Trident Independent Energy System process as explained and exemplified hereinbefore;
12) having one or more AC switching devices disposed within the electrical wiring in a capable and suitable manner of the given application of the Trident Independent Energy System process as explained and exemplified hereinbefore;
13) having an undeterminable structural frame system, if necessary, that is capable and suitable to securely support the components and devices of the given application of the Trident Independent Energy System process as explained and exemplified hereinbefore;
14) ensuring that the shaft(s) of the one or more AC continuous duty motor(s) is mechanically connected to the one or more modified flywheel(s) for the given application of the Trident Independent Energy System process in a like manner as explained and exemplified hereinbefore;
15) ensuring that one or more AC starter system(s) has been configured and engineered in a capable and suitable manner for the given application of the Trident Independent Energy System process that will engage the one or more modified flywheel(s) as explained and exemplified hereinbefore;
16) ensuring that the wiring and connections of the selected electrical components and devices and the lines and fittings of the selected hydraulic components for the given application of the Trident Independent Energy System process are connected and secured in a like manner as explained and exemplified hereinbefore; and
17) ensuring that the selected electrical and hydraulic components and devices of the given application of the Trident Independent Energy System process have been assembled and are secure in a like manner as explained and exemplified hereinbefore, the given application of the Trident Independent Energy System process may be started as explained and exemplified hereinbefore, where the resultant effect is generating mechanical and electrical energy as described hereinbefore and in the forthcoming abstract

3. The Trident Independent Energy System process of claim 1 is capable of operating on and/or generating alternating current, AC, direct current, DC, or a combination of both, including AC and/or DC components and devices as explained and exemplified hereinbefore;

4. The Trident Independent Energy Systems process of claim 1 is capable of direct and/or indirect mechanical connection with one another with the incorporation of gears, shafts, pulleys, DRIVE-BELTS, differential gears, universal joints, transmissions, clutches and the likes thereof as explained and exemplified hereinbefore;

5. the Trident Independent Energy System process of claim 1 concerning the generating of electricity, per system, is limited to only the generating capacity of available generators and/or alternators;

6. the Trident Independent Energy System process of claim 1 is highly scalable where a plurality of Trident Independent Energy Systems are capable of being electrically connected to one another to produce a desired result, as has been explained hereinbefore;

7. the Trident Independent Energy System process of claim 1 is limited only to ensuring that the configuration of components and devices have a secure mechanical and electrical connection between said components and devices as explained and exemplified hereinbefore;

8. the Trident Independent Energy System process of claim 1 is not limited to stationary embodiments as explained and exemplified hereinbefore;

9. the Trident Independent Energy System process of claim 1, wherein a given embodiment presents a modified flywheel torque issue, said issue may be counteracted by the configuration of a second equally weighted modified flywheel on the same axis as explained and exemplified hereinbefore;

10. the Trident Independent Energy System process of claim 1, wherein the electrical components are capable of being in the immediate proximity of one another are further capable of being at some distance from one another with the incorporation of capable and suitable wiring, components and devices having capable and suitable connections as explained and exemplified hereinbefore;

11. the Trident Independent Energy System process of claim 1 wherein the modified flywheel is able to be substituted with another weighted configuration, so long as the weighted configuration accomplished the desired result of the modified flywheel(s) as explained hereinbefore;

12. the Trident Independent Energy System process of claim 1, wherein the continuous duty AC motor is able to be substituted with other AC and/or DC motors of various horsepower, so long as the substituted AC and/or DC motor accomplishes the desired result as explained and exemplified hereinbefore;

13. the Trident Independent Energy System process of claim 2 is capable or operating on and/or generating alternating current, AC, direct current, DC, or a combination of both, including AC and/or DC components and devices as explained and exemplified hereinbefore;

14. the Trident Independent Energy System process of claim 2 is capable of direct and/or indirect mechanical connections with one another with the incorporation of gears, universal joints, shafts, pulleys, DRIVE-BELTs differential gears, transmissions, clutches and the likes thereof as explained and exemplified hereinbefore;

15. the Trident Independent Energy System process of claim 2 wherein hydraulic and electrical components are capable of being in the immediate proximity of one another or at some distance apart from one another with the incorporation of capable and suitable hydraulic lines and fittings and electrical wire and connectors as explained and exemplified hereinbefore;

16. the Trident Independent Energy System process of claim 2 is highly scalable where a plurality of Trident Independent Energy Systems are capable of being electrically and hydraulically connected to one another in order to produce a desired results has been explained hereinbefore;

17. the Trident Independent Energy System process of claim 2, wherein the configuration of components is limited to only ensuring efficient and secure mechanical, electrical and hydraulic connections between the components and devices thereof, in order to produce a desired result as explained hereinbefore;

18. the Trident Independent Energy System process of claim 2 is not limited to stationary embodiments as explained hereinbefore;

19. the Trident Independent Energy System process of claim 2, wherein a given embodiment presents a modified flywheel torque issue, said issue may be counteracted by the configuration of an equally weighted second modified flywheel on the same axis as explained and exemplified hereinbefore;

21. the Trident Independent Energy System process of claim 2 wherein the modified flywheel is able to be substituted with another weighted configuration, so long as the weighted configuration accomplishes the desired result of the modified flywheel(s) as explained hereinbefore; and

22. the Trident Independent Energy System process of claim 2, wherein the continuous duty AC motor is able to be substituted with an AC and/or DC motor of various horsepower, so long as the substituted AC and/or DC motor accomplishes the desired result an explained and exemplified hereinbefore
